(19) United States
(12) Patent Application Publication
(10) Pub. No.: US 2009/0043703 A1
(43) Pub. Date: Feb. 12, 2009

(54) Transaction method and system in search region

(75) Inventor: Wen-Shan Chen, Kaohsiung City (TW)

Correspondence Address: BIRCH STEWART KOLASCH & BIRCH, PO BOX 747, FALLS CHURCH, VA, 22040-0747, US

(73) Assignee: Mitac International Corp.

(21) Appl. No.: 11/882,859

(22) Filed: Aug. 6, 2007

(51) Int. Cl. G06Q 30/00

(52) U.S. Cl. 705/41

(57) ABSTRACT

A method and system are designed for transaction in a search region. The transaction system includes merchant servers and a portable electronic device. The portable electronic device further includes a calculation module, a communication module, a positioning module, and a display module. The portable electronic device is used to search the merchant servers in a set range, and transaction is performed through wireless communication transmission. The transaction method includes positioning the portable electronic device by the portable electronic device itself and setting an effective range according to the position of the portable electronic device; searching the merchant servers in the effective range; selecting one from the merchant servers as a transaction server; performing a transaction procedure between the portable electronic device and the transaction server. After the transaction is ended, the transaction server sends back an acknowledgement message to the portable electronic device.

### BACKGROUND OF THE INVENTION

1. Field of the Invention

The present invention relates to a transaction method and system in a search region, and more particularly to an on-line transaction method and system applicable for a portable electronic device and stores in an effective range.

2. Related Art

As the Global Positioning System (GPS) has been increasingly matured, it is mostly applied in a navigation device. Generally, a navigation system is often used on a vehicle for positioning and inquiring a map during traveling. Firstly, a GPS receiver obtains the position information of the vehicle through a satellite signal. Next, the navigation device marks a corresponding position on the map according to the position information, and then plays the map around the GPS receiver on a display unit. Then, a user may set a site where he/she heads for, and then, the navigation device calculates a corresponding traveling path for the user's reference.

Besides the application in the navigation device, the GPS may also be combined with life information. For example, the GPS may be combined with photographing information, and may record a photographing position when a user takes a photograph, such that the user may classify the photos in a more convenient way.

Taiwan Patent Publication No. 561384 discloses “a commodity transaction system and method in a moving vehicle”, in which an on-vehicle wireless order device is used to communicate with a call center server. A user inquires a desired commodity to the call center server. Next, the call center server will list stores or shops where this commodity is available near the user according to the user's position. Then, after the user selects the shop, the call center server accesses the selected merchant computer. After the user determines to buy the desired commodity, the transaction mode and time are sent back to the merchant computer. Finally, the user may drive to the store to take his commodity according to the set transaction time.

The centralized management of the information of the stores through a call center server may achieve the purpose of inquiring a commodity rapidly. However, with regard to each of enterprise entities, how to jointly maintain the operation of the call center server is a key point, such as the commodity management or store classification of the call center server. Furthermore, if something wrong happens with the call center server, the whole transaction system cannot run at all.

### SUMMARY OF THE INVENTION

In view of the above problems, the present invention is mainly directed to a transaction method in a search region, such that a portable electronic device searches the merchant servers in the set range and selects corresponding wireless network transmission for performing the transaction depending on environment.

In order to achieve the aforementioned objects, the present invention provides a transaction method in a search region, which includes the following steps. Firstly, the portable electronic device positions its own position, and then, an effective range is set according to the position of the portable electronic device. Next, a navigation communication device finds out merchant servers of the effective range. Then, one of the merchant servers is selected as a transaction server. Thereafter, a transaction procedure is performed between the portable electronic device and the transaction server.

In another aspect of the present invention, the present invention provides a transaction system in a search region. The transaction system includes merchant servers and a portable electronic device. The merchant servers are disposed in different stores respectively and used to provide services of inquiring the commodities and transaction. The portable electronic device is used to position its own position and communicates with the merchant servers. The portable electronic device further includes a calculation module, a communication module, a positioning module, and a display module. The calculation module is used to perform the calculation process of relevant functions of the portable electronic device, sets an effective range according to the current position, and searches the merchant servers in the effective range. The communication module is electrically connected to the calculation module, and used to transfer or receive communication data. The positioning module is electrically connected to the communication module and the calculation module, and used to position the current position and the effective range of the communication device. The display module is electrically connected to the calculation module, and used to display the information of the portable electronic device in positioning and shopping transaction.

According to an embodiment of the present invention, in the aforementioned method and system, the portable electronic device is positioned and an effective range is set according to the position of the portable electronic device. Next, merchant servers are searched in the effective range and one is selected as a transaction server, which will provide a list of commodities in the stores to the portable electronic device. Then, the user selects the commodities to be bought according to the list of commodities. After the transaction procedure is ended, the portable electronic device will receive an acknowledgement message from the transaction server. Finally, the user goes to take the commodity according to the acknowledgement message.

In the present invention, the stores in the range of the portable electronic device are searched by the portable electronic device, and desired commodities are ordered on line through a network transmission mechanism. Therefore, not only the user saves time in waiting for taking commodities, but also the stores reduce relevant selling and administrative expenses. Furthermore, it is unnecessary to additionally set a call center server in the system to manage the stores and commodities.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of the architecture of the present invention.

FIG. 2 is a schematic view of the flow of the present invention.

FIG. 3 is a schematic view of the flow of the transaction procedure of the present invention.

FIG. 4a is a schematic view of graphic information displayed by a navigation and positioning device of the present invention.

FIG. 4b is a schematic view of graphic information displayed by the navigation and positioning device of the present invention.

FIG. 5 is a schematic view of the commodity category list.

FIG. 6 is a schematic view of the format of the acknowledgement message.

FIG. 7 is a schematic view of another embodiment of the present invention.

### DETAILED DESCRIPTION OF THE INVENTION

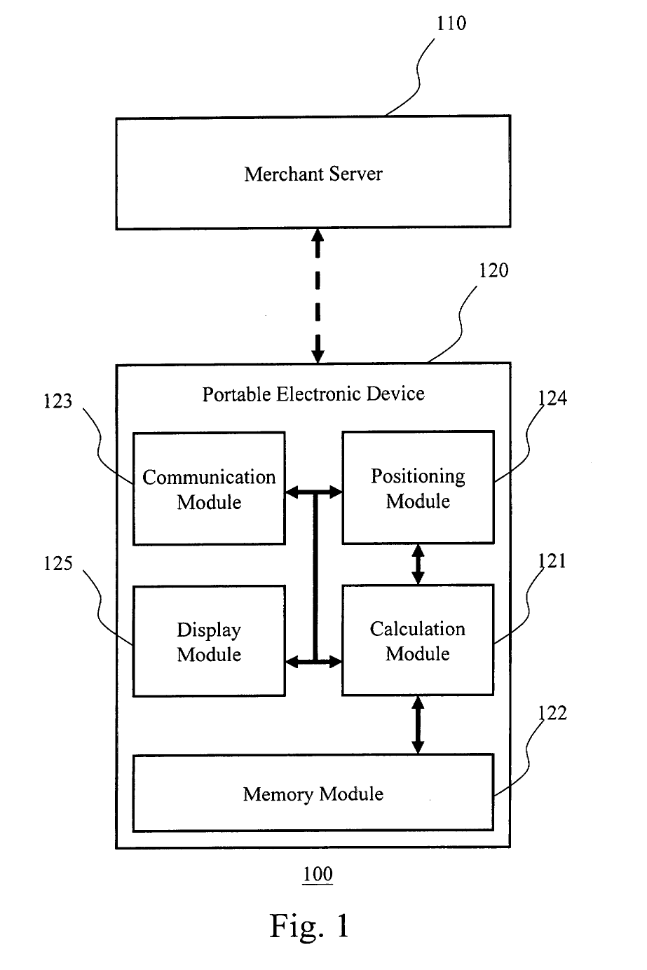

A transaction system 100 in a search region is provided in the present invention. FIG. 1 is a schematic view of the architecture of the present invention. The transaction system 100 in the search region includes merchant servers 110 and a portable electronic device 120. The merchant servers 110 are disposed in different merchants respectively, so as to provide services of inquiring commodities and transaction. Each of the merchant servers 110 further includes a commodity category list to record a plurality of commodity categories and a plurality of selected commodities. The portable electronic device 120 is used to position its own position and communicates with the merchant servers 110. The portable electronic device 120 further includes a calculation module 121, a memory module 122, a communication module 123, a positioning module 124, and a display module 125. The calculation module 121 is mainly used to perform calculation process of relevant functions of the portable electronic device 120. The memory module 122 is electrically connected to the calculation module 121, and used to store the graphic information data required by the positioning module 124, and the graphic information data includes the geographic graphic information and coordinate information of sight spots or stores. After the user inputs the sight spot or the coordinate value to be inquired, the calculation module 121 searches the geographic information meet the above requirements according to the input value.

The communication module 123 is electrically connected to the calculation module 121, and used to transfer or receive the communication data. The communication module 123 may be formed by a GSM system, an 802.11a/b/g/n wireless network, or a WiMAX module, such that the communication module 123 may access the network according to different environments, thereby achieving the purpose of online shopping. For example, if the portable electronic device 120 is used in a vehicle moving at a high speed, the communication module 123 may be switched to GPRS or 3G to access the network. If the portable electronic device 120 is used in a vehicle traveling at a low speed (such as a motorcycle or a person who walks on the way), the communication module 123 may be switched to a wireless network to access the network. Of course, if the data of the stores is updated, the graphic information data in the portable electronic device 120 may also be updated by downloading the updated data from the network.

The positioning module 124 is electrically connected to the communication module 123 and the calculation module 121, and used to position the current communication device and to determine the effective range. The positioning module 124 is used for positioning and may achieve the positioning purpose through GPS or GSM/3G system.

The calculation module 121 is positioned by the positioning module 125 to set an effective range, and then, the calculation module 121 searches the merchant servers 110 in the effective range. The communication module 123 is communicated with the selected merchant server 110. The display module 125 is electrically connected to the calculation module 121, so as to display the information about positioning and transaction. For example, if the portable electronic device 120 sets the effective range as an area with a radius of 500 meters and searches quick service restaurants in this range, the calculation module 121 will compare the quick service restaurants in the graphic information data to get those in the coordinate range. Then, the display module 125 displays the quick service restaurants searched by the calculation module 121, together with the graphic information data, on a display screen, for being selected by the user.

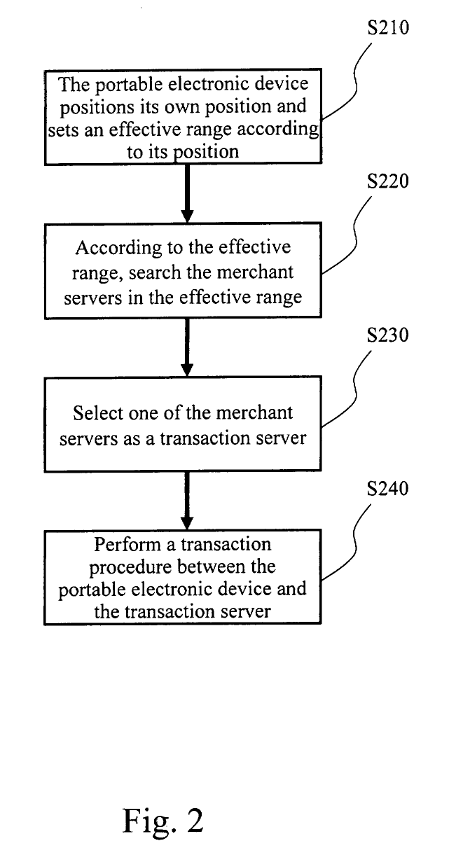

The operating procedures of each component in the present invention will be explained by referring to FIGS. 1 and 2. FIG. 2 is a schematic view of the flow of the present invention. Firstly, the portable electronic device 120 is positioned, and an effective range is set according to the position of the portable electronic device 120 (Step S210). Next, a navigation communication device searches the merchant servers 110 in the effective range (Step S220). Then, one of the merchant servers 110 is selected as a transaction server (Step S230). Subsequently, a transaction procedure is performed between the portable electronic device 120 and the transaction server (Step S240).

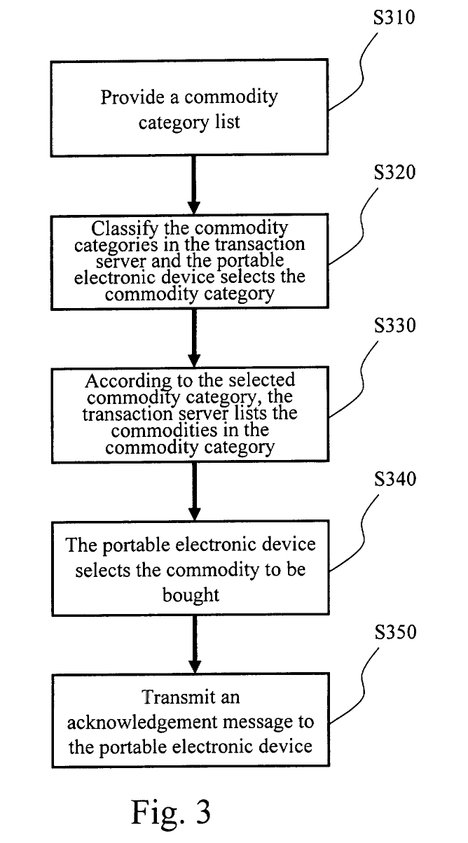

The step of performing the transaction procedure between the portable electronic device 120 and the transaction server 130 further includes the following steps. As shown in FIG. 3, it is a schematic view of the flow of the transaction procedure of the present invention. Firstly, a commodity category list is provided (Step S310). Next, the commodity categories in the transaction server are classified, and the portable electronic device 120 selects a commodity category (Step S320). Then, according to the commodity category selected by the portable electronic device 120, the transaction server lists the selectable commodities in the commodity category (Step S330). Then, the portable electronic device 120 selects the commodities to be bought and finish a payment procedure (Step S340). Finally, the transaction server transfers an acknowledgement message to the portable electronic device 120 (Step S350).

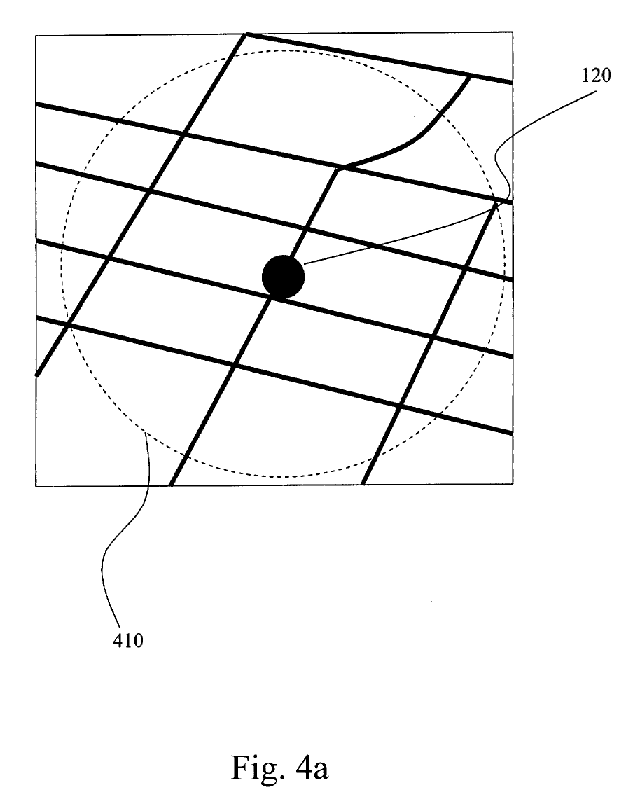

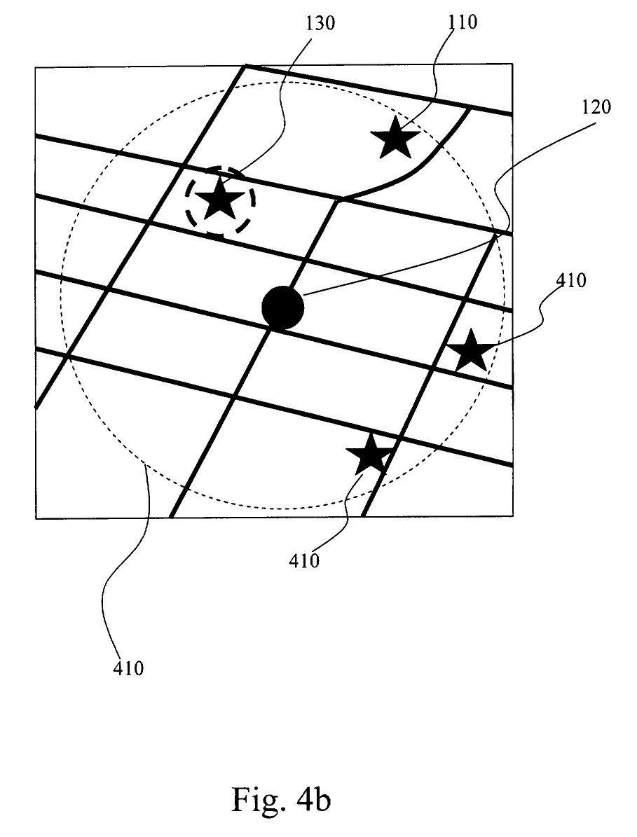

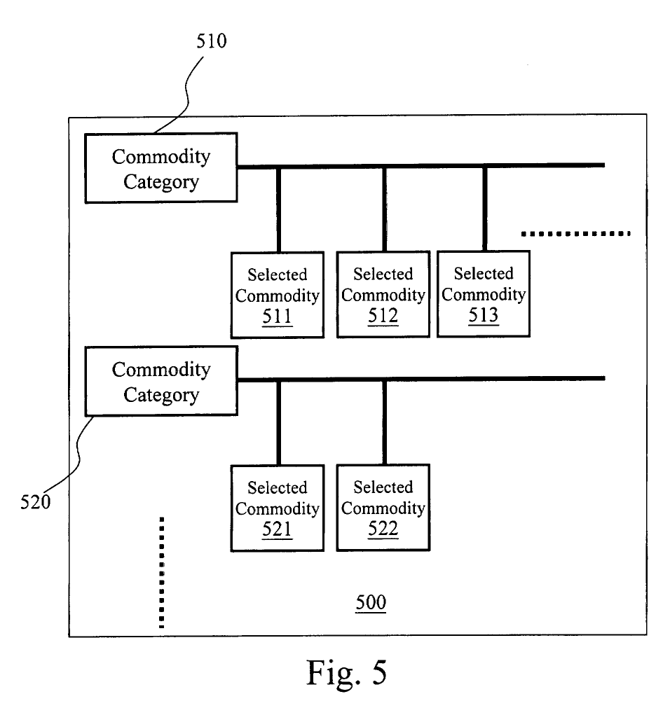

Referring to FIGS. 4a, 4b, and FIG. 5, the flow of the whole transaction system 100 of the present invention is explained. FIGS. 4a and 4b are respectively schematic views of the graphic information shown by a navigation and positioning device of the present invention. Herein, it is assumed that the portable electronic device 120 uses GPS as the positioning module 124, and the communication module 123 accesses the network through the 3G communication system.

The black spot in FIG. 4a represents the position of the portable electronic device 120, and the portable electronic device 120 may be mounted in automobiles or other vehicles. The portable electronic device 120 firstly should be positioned (corresponding to Step S210), as shown in FIG. 4a. Next, the portable electronic device 120 sets an effective range 410 (corresponding to Step S220), and in FIG. 4a, the effective range 410 is represented by a thin dash line. For example, according to the stores under search and the effective range 410, the calculation module 121 shows the stores meeting the requirements to the user through the display module 125. As for the setting of the effective range 410, the radius with the portable electronic device 120 as a center may be taken as a sifting condition or the sifting condition may be set as the area of specific streets. Then, the calculation module 121 compares the stores in the effective range 410 according to the graphic information data in the memory module 122.

Referring to FIG. 4b, asterisks represent the merchant servers 110. Subsequently, the user selects one from the merchant servers 110 as the transaction server 130, and begins the transaction procedure (corresponding to Steps S230-240). Referring to FIG. 4b, the asterisk surrounded by a heavy dash line represents the transaction server 130. Additionally, the portable electronic device 120 may select different network transmission methods depending upon a current environment. For example, at an express highway, the portable electronic device 120 may access the Internet through GPRS/3G. In a downtown area, the portable electronic device 120 may select a wireless network.

At this time, the transaction server 130 transmits the commodity category list 500 to a navigation communication module 120. Referring to FIG. 5, it is a schematic view of the commodity category list. The commodity category list 500 includes various commodity categories and selectable commodities. When the user selects a different commodity category, the transaction server 130 will transfer the information of the selectable commodities in this commodity category to the portable electronic device 120. The user selects the desired commodities according to the commodity category list 500 (corresponding to Steps S310-320). After the desired commodities are selected, the user may finish the payment through different ways, such as online payment by a card, cash payment or ATM account transfer. Once this transaction is finished, the transaction server 130 transfers the acknowledgement message 400 to the portable electronic device 120. In a similar way, the portable electronic device 120 will also transfer a transaction message or an E-mail to the transaction server 130 (corresponding to Steps S330-S350). Finally, the user goes to the store to take the ordered commodities in a set transaction time.

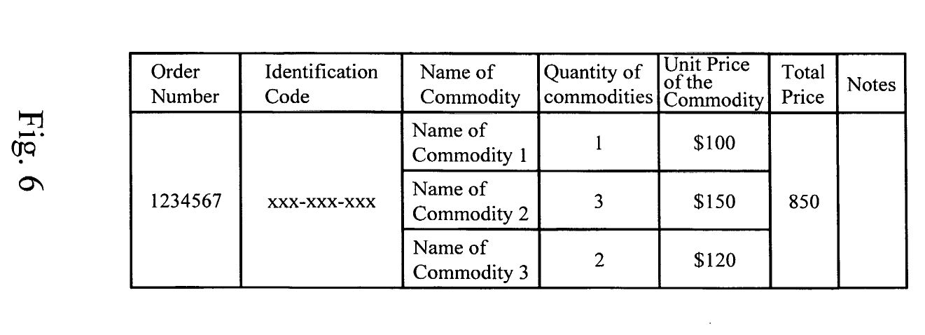

Referring to FIG. 6, it is a schematic view of the format of the acknowledgement message. The acknowledgement message 400 includes (but not limited to) shopping information, such as an order number, an identification code, the quantities of selected commodities, a transaction time, a payment method, and a total price. The identification code may be one of a mobile phone number, a user's ID number, or a serial number, and the identification code is offered to the store of the transaction server 130 for identifying the identity of the buyer.

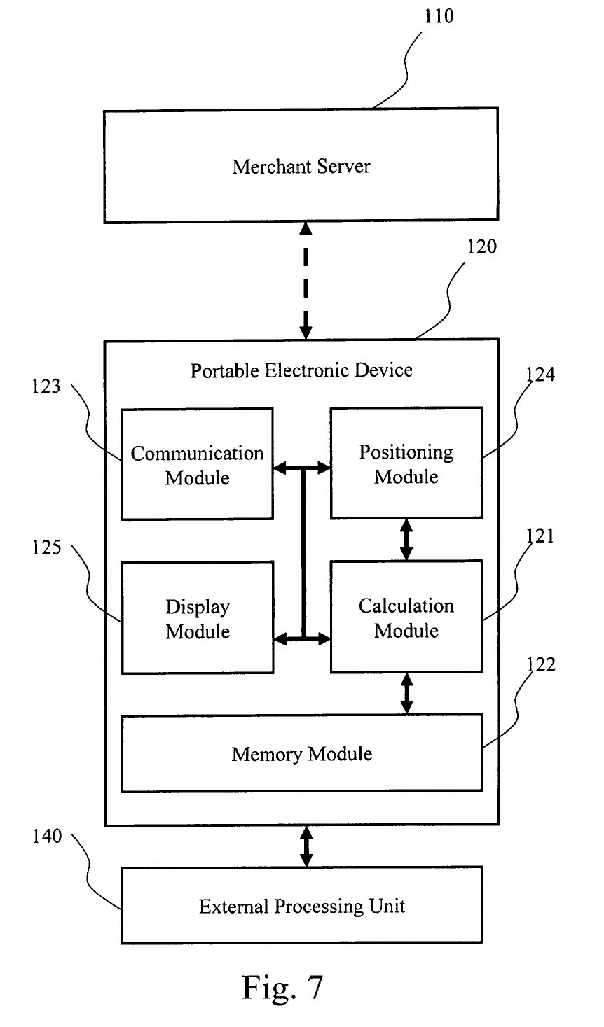

Referring to FIG. 7, it is a schematic view of another preferred embodiment of the present invention. The composition of the components is substantially the same as those in the aforementioned embodiment, which thus will not be repeated herein. This embodiment is different from the aforementioned embodiment in that, the communication module 123 in the portable electronic device 120 includes (but not limited to) a Bluetooth module. The portable electronic device 120 communicates with an external processing unit 140 through the communication module 123. The external processing unit 140 may be a mobile phone or a notebook computer. After the portable electronic device has searched the merchant servers 110 in the effective range, the portable electronic device 120 will establish network connection with the transaction server 130 through the external processing unit 140.

In the present invention, the stores in the range of the portable electronic device 120 are searched by the portable electronic device 120, and desired commodities are ordered on line through an online ordering mechanism. Therefore, not only the user saves time in waiting for taking commodities, but also the merchants reduce relevant selling and administrative expenses. Furthermore, it is unnecessary to additionally set a call center server in the transaction system 100 to manage the stores and commodities. Furthermore, the portable electronic device 120 directly accesses the servers of the stores to perform the transaction, so as to avoid the situation that the whole transaction system is broken down due to the malfunction of the call center server.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A transaction method in a search region, applied in a portable electronic device to perform data search and transaction on a plurality of merchant servers in a specific range, the merchant servers being located in different stores, the method comprising:
positioning the position of the portable electronic device by the portable electronic device itself and setting an effective range according to the position of the portable electronic device;
searching the merchant servers in the effective range, according to the effective range;
selecting one from the merchant servers as a transaction server; and
performing transaction between the portable electronic device and the transaction server.

2. The transaction method in the search region as claimed in claim 1, wherein the portable electronic device transfers a short message to the merchant servers through a Global System for Mobile Communications (GSM) or a third generation (3G) mobile communication system.

3. The transaction method in the search region as claimed in claim 1, wherein the portable electronic device transfers transaction information or an E-mail to the merchant servers through a wireless network.

4. The transaction method in the search region as claimed in claim 1, wherein the step of searching the merchant servers in the effective range further comprises:
selecting an index keyword; and searching the merchant servers meeting the index keyword requirement.

5. The transaction method in the search region as claimed in claim 1, wherein the step of performing transaction between the portable electronic device and the transaction server further comprises:
providing a commodity category list;
classifying a plurality of commodity categories in the transaction server, wherein the portable electronic device selects a commodity category;
according to the commodity category, the transaction server listing a plurality of selected commodities in the commodity category;
making the portable electronic device select the commodities and finish a payment procedure; and
transferring an acknowledgement message to the portable electronic device.

6. The transaction method in the search region as claimed in claim 5, wherein the acknowledgement message further comprises an order number, an identification code, the quantity of the selected commodities, a transaction time, a payment method, and a total price.

7. The transaction method in the search region as claimed in claim 6, wherein the identification code is a mobile phone number, a user ID number, or a serial number.

8. The transaction method in the search region as claimed in claim 6, wherein the payment method is online payment by a card, cash payment, or ATM account transfer.

9. A transaction system in a search region, comprising:
a plurality of merchant servers, disposed in different stores respectively, so as to provide services of inquiring commodities and transaction; and
a portable electronic device, used for communication and positioning, the portable electronic device further comprising:
a calculation module, for performing calculation process of relevant functions of the portable electronic device, setting an effective range according to the current position, and searching the merchant servers in the effective range;
a memory module, electrically connected to the calculation module, and used for storing graphic information data;
a communication module, electrically connected to the calculation module, and used for transferring or receiving the communication data;
a positioning module, electrically connected to the communication module and the calculation module, and used for positioning a current position of the communication device; and
a display module, electrically connected to the calculation module, and used for displaying information on positioning and transaction.

10. The transaction system in the search region as claimed in claim 9, wherein the communication module transfers a short message or a speech signal to the merchant servers through a Global System for Mobile Communications (GSM) or a third generation (3G) mobile communication system.

11. The transaction system in the search region as claimed in claim 9, wherein the communication module transfers transaction information or an E-mail to the merchant servers through a wireless network.

12. The transaction system in the search region as claimed in claim 11, wherein the wireless network is 802.11x network protocol or WiMAX.

13. The transaction system in the search region as claimed in claim 9, wherein the merchant server comprises a commodity category list to record a plurality of commodity categories and a plurality of selected commodities.
